(19) United States
(12) Patent Application Publication
(10) Pub. No.: US 2016/0080470 A1
(43) Pub. Date: Mar. 17, 2016

(54) SERVER-SIDE PLAYLIST STITCHING

(71) Applicant: Net2.TV, LTD., San Mateo, CA (US)

(72) Inventor: Spencer SHANSON, Menlo Park, CA (US)

(21) Appl. No.: 14/852,061

(22) Filed: Sep. 11, 2015

Related U.S. Application Data
(60) Provisional application No. 62/050,026, filed on Sep. 12, 2014.

(51) Int. Cl. H04L 29/08; G11B 27/10; H04N 21/845; H04N 21/262; H04N 21/2187

(52) U.S. Cl. CPC H04L 67/06; H04L 67/02; H04N 21/26258; H04N 21/2187; H04N 21/8456; G11B 27/10

(57) ABSTRACT

Described herein are techniques for providing a client device with a requested streamed video by stitching video segments and break segments into a playlist from a stitching server. The stitching server can receive a request from a client device to receive streamed video. The stitching server can retrieve first metadata representing the streamed video, wherein the first metadata includes offset information for one or more breaks in the streamed video, wherein each break contains one or more break segments. The stitching server can request and receive, from a second server, second metadata for the one or more break segments. The stitching server can create a playlist for the streamed video by stitching the second metadata into the first metadata at one or more locations indicated by the first metadata. The stitching server can then provide the playlist to the client device.

### RELATED APPLICATIONS

This application relates to and claims priority under 35 U.S.C. §119(e) to U.S. Provisional Patent Application No. 62/050,026, filed on Sep. 12, 2014, which is hereby incorporated herein by reference in its entirety.

### FIELD

The subject matter disclosed in this application generally relates to the field of digital content distribution and, more specifically, to providing an integrated digital content by stitching multiple video streams and dynamically inserting break segments such as advertisements and/or public announcements.

### BACKGROUND

Today, with the ubiquity of multimedia digital content such as video streams that are available from the Internet, consumers spend some time watching video streams on client devices as well as watching traditional television. However, due to restrictions (e.g., content size and/or content length) of websites from which the multimedia digital content is available, video streams are oftentimes available as short segments of a full-length episode. For example, a 40-minute television episode can be fragmentized into eight 5-minute segments. Traditionally, there are several issues associated with watching short video segments on a client device. First, to play a full-length episode, the client device has to stream each individual segment. Therefore, the transition between video segments is not seamless as the video player has to buffer each new stream when the previous one has ended. Second, to transition from one segment to the next one in the sequence, the client device has to know the URL to the file for each video segment. This increases the complexity of the client application.

Therefore, there is a need in the art to provide systems and methods for improving users' viewing experience. Accordingly, it is desirable to provide methods and systems that overcome these and other deficiencies of the related art.

### SUMMARY

In accordance with the disclosed subject matter, systems, methods, and computer readable media are disclosed for providing streamed video to client devices.

Disclosed subject matter includes, in one aspect, a computerized method. The method includes receiving, by a first server, a request from a client device to receive streamed video. The method includes retrieving, by the first server, first metadata representing the streamed video, wherein the first metadata includes offset information for one or more breaks in the streamed video, wherein each break contains one or more break segments. The method includes requesting, by the first server from a second server, second metadata for the one or more break segments. The method includes receiving, by the first server from the second server, the second metadata for the one or more break segments. The method includes creating, by the first server, a playlist for the streamed video by stitching the second metadata into the first metadata at one or more locations indicated by the first metadata. The method includes providing, by the first server, the playlist to the client device.

Disclosed subject matter includes, in another aspect, an apparatus. The apparatus includes one or more processors. The apparatus includes a memory storing a program that, when executed, causes the one or more processors to receive a request from a client device to receive streamed video. The program, when executed, causes the one or more processors to retrieve first metadata representing the streamed video, wherein the first metadata includes offset information for one or more breaks in the streamed video, wherein each break contains one or more break segments. The program, when executed, causes the one or more processors to request, from a first server, second metadata for the one or more break segments. The program, when executed, causes the one or more processors to receive, from the first server, the second metadata for the one or more break segments. The program, when executed, causes the one or more processors to create a playlist for the streamed video by stitching the second metadata into the first metadata at one or more locations indicated by the first metadata. The program, when executed, causes the one or more processors to provide the playlist to the client device.

Disclosed subject matter includes, in yet another aspect, a non-transitory computer readable medium comprising executable instructions. The instructions are operable to cause an apparatus to receive a request from a client device to receive streamed video. The instructions are operable to cause the apparatus to retrieve first metadata representing the streamed video, wherein the first metadata includes offset information for one or more breaks in the streamed video, wherein each break contains one or more break segments. The instructions are operable to cause the apparatus to request, from a first server, second metadata for the one or more break segments. The instructions are operable to cause the apparatus to receive, from the first server, the second metadata for the one or more break segments. The instructions are operable to cause the apparatus to create a playlist for the streamed video by stitching the second metadata into the first metadata at one or more locations indicated by the first metadata. The instructions are operable to cause the apparatus to provide the playlist to the client device.

Before explaining example embodiments consistent with the present disclosure in detail, it is to be understood that the disclosure is not limited in its application to the details of constructions and to the arrangements set forth in the following description or illustrated in the drawings. The disclosure is capable of embodiments in addition to those described and is capable of being practiced and carried out in various ways. Also, it is to be understood that the phraseology and terminology employed herein, as well as in the abstract, are for the purpose of description and should not be regarded as limiting.

These and other capabilities of embodiments of the disclosed subject matter will be more fully understood after a review of the following figures, detailed description, and claims.

It is to be understood that both the foregoing general description and the following detailed description are explanatory only and are not restrictive of the claimed subject matter.

### BRIEF DESCRIPTION OF THE DRAWINGS

Various objects, features, and advantages of the disclosed subject matter can be more fully appreciated with reference to the following detailed description of the disclosed subject matter when considered in connection with the following drawings.

FIG. 1 illustrates a block diagram of a networked computing environment for providing one or more client devices with requested streamed video, according to some embodiments of the disclosed subject matter.

FIG. 2 illustrates a computerized process of providing one or more client devices with requested streamed video, according to some embodiments of the disclosed subject matter.

FIG. 3 illustrates a computerized process of stitching one or more segments into a playlist, according to some embodiments of the disclosed subject matter.

FIG. 4 illustrates a computerized process 400 of dynamically inserting advertisements into a stitched playlist, according to some embodiments of the disclosed subject matter.

FIG. 5 illustrates a block diagram of a stitching server, according to some embodiments of the disclosed subject matter.

FIG. 6 illustrates a representation of a requested episode with break segments, according to some embodiments of the disclosed subject matter.

FIG. 7 illustrates a representation of a requested episode with stitched advertisements, according to some embodiments of the disclosed subject matter.

FIG. 8 illustrates a data structure that includes three different playlists based on different bandwidth indices, according to some embodiments of the disclosed subject matter.

FIG. 9 illustrates a playlist with multiple episodes, according to some embodiments of the disclosed subject matter.

FIG. 10 illustrates a playbar with break locations, according to some embodiments of the disclosed subject matter.

### DESCRIPTION

In the following description, numerous specific details are set forth regarding the systems and methods of the disclosed subject matter and the environment in which such systems and methods may operate, in order to provide a thorough understanding of the disclosed subject matter. It will be apparent to one skilled in the art, however, that the disclosed subject matter may be practiced without such specific details, and that certain features, which are well known in the art, are not described in detail in order to avoid complication of the disclosed subject matter. In addition, it will be understood that the embodiments described below are only examples, and that it is contemplated that there are other systems and methods that are within the scope of the disclosed subject matter.

The disclosed subject matter is directed to improved systems, methods, and computer readable media for providing streamed video to client devices. In some embodiments, the streamed video is composed of multiple shorter video streams (segments) and dynamically inserted break segments. The segments can be assembled together into a linear playlist. In some embodiments, other suitable types of playlist can also be created. Each individual segment represents a single piece of transcoded content hosted on a server (as a non-limiting example, the server can be a content delivery network). In some embodiments, the streamed video can be a full-length television episode, multiple television episodes, or a subset of a television episode. In some embodiments, the streamed video can be any other suitable content. In some embodiments, the break segment can be an advertisement segment, a public announcement, or any other suitable content.

In some embodiments, the streamed video is compatible with Apple's Hypertext Transfer Protocol (HTTP) Live Streaming (HLS) adaptive streaming protocol (incorporated fully herein by reference and which may be found, for example at https://tools.ietf.org/html/draft-pantos-http-live-streaming-13?), and any associated HLS .m3u8 manifest files and .ts chunks can be generated by transcoding service and delivered by a server such as a content delivery network or a stitching server. Because the streamed video can include multiple segments, and each segment may have a corresponding HLS .m3u8 manifest file, to simplify and improve users' viewing experience, the disclosed subject matter implements a server-side playlist stitcher that converts the multiple HLS .m3u8 manifest files for the streamed video (which can be a partial episode, a whole episode, or multiple episodes) into a single HLS .m3u8 manifest file. In some embodiments, the streamed video can be compatible with a non-standard version of the HLS protocol or any other suitable streaming protocols.

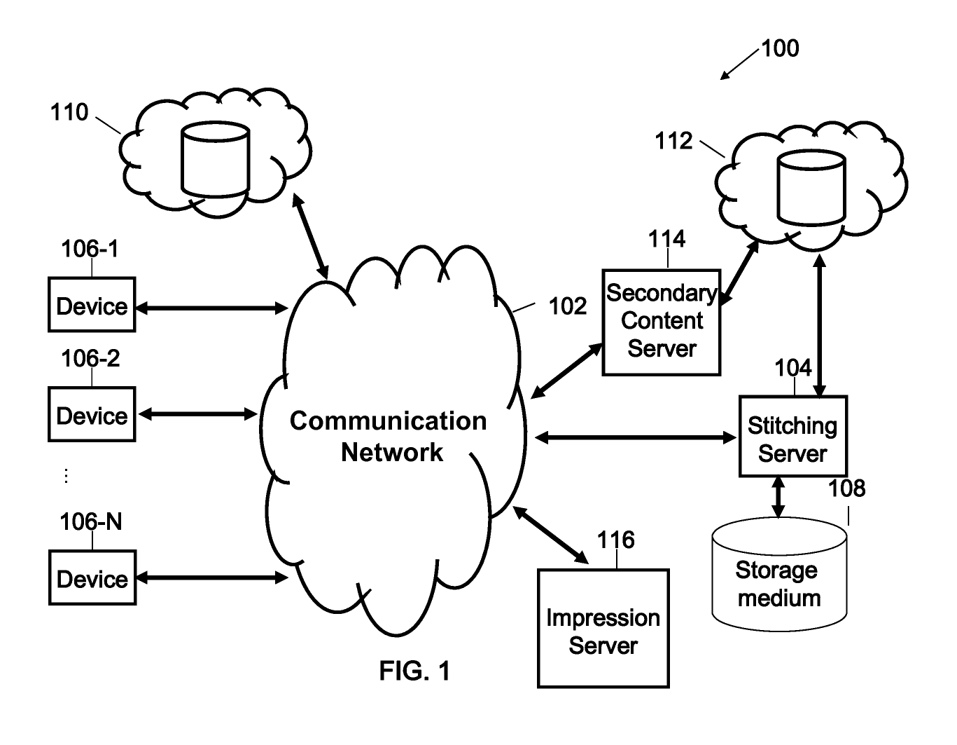

The disclosed embodiments can be implemented in a networked computing environment. FIG. 1 illustrates an exemplary networked computing environment 100 in accordance with some embodiments. The networked computing environment 100 can include a stitching server 104, a secondary content server 114, an impression server 116, at least one client device 106 (e.g., client device 106-1, 106-2, 106-N), a physical storage medium 108, and cloud storage media 110 and 112, which can all be coupled directly or indirectly to a communication network 102. The components included in the networked computing environment 100 can be further broken down into more than one component and/or combined together in any suitable arrangement. Further, one or more components can be rearranged, changed, added, and/or removed. For example, in some embodiments, the stitching server 104, the secondary content server 114, and/or the impression server 116 can be combined into one or more servers.

Each client device 106 can communicate with the stitching_server 104 to send data to, and receive data from, the stitching server 104 across the communication network 102. Each client device 106 can be directly coupled to the stitching server 104. Additionally, each client device 106 can be connected to the stitching server 104 via any other suitable devices, communication networks, or combination thereof. For example, each client device 106 can be coupled to the stitching server 104 via one or more routers, switches, access points, and/or communication network (as described below in connection with communication network 102). A client device 106 can include, for example, a desktop computer, a mobile computer, a tablet computer, a cellular device, a smartphone, television, or any computing systems that are capable of performing computation. The client device 106 can include a module that is configured to enable a user to request a particular episode of a media item. In some embodiments, the client device 106 can also be referred to as a media playing device. In some embodiments, the client device 106 can be an HLS complaint HLS player. In some embodiments, the client device 106 can be a Portico media player provided by Net2TV.

The stitching server 104 can receive a request from a client device 106 to receive streamed video. The stitching server 104 can then retrieve first metadata representing the streamed video. The first metadata includes offset information for one or more breaks in the streamed video, and each break contains one or more break segments. The stitching server 104 can request and receive from the secondary content server 114 second metadata for the one or more break segments. The stitching server 104 can create a playlist for the streamed video by stitching the second metadata into the first metadata at one or more locations indicated by the first metadata. The stitching server 104 can then provide the playlist to the client device 106. In some embodiments, the stitching server 104 can also be referred to as a stitcher, a playlist stitcher, and/or a playlist stitching server. The stitching server 104 can be coupled to one or more physical storage media and/or one or more cloud storage media, which can be configured to store data for the stitching server 104. FIG. 1 shows the stitching server 104 and the physical storage medium 108 as separate components; however, the stitching server 104 and physical storage medium 108 can be combined together. FIG. 1 also shows the stitching server 104 as a single server; however, the stitching server 104 can include more than one server. FIG. 1 shows the physical storage medium 108 as a single physical storage medium; however, physical storage medium 108 can include more than one physical storage medium. The physical storage medium 108 can be located in the same physical location as the stitching server 104, at a remote location, or any other suitable location or combination of locations.

The secondary content server 114 can provide second metadata for the one or more break segments. The second metadata can be stitched into a playlist by the stitching server 104. FIG. 1 shows the secondary content server 114 as a single server; however, the secondary content server 114 can include more than one server. The secondary content server 114 can be coupled to one or more physical storage media and/or one or more cloud storage media, which can be configured to store data for the secondary content server 114.

The impression server 116 can track each time the one or more break segments are played, in whole or in part, by the client device 106. FIG. 1 shows the impression server 116 as a single server; however, the impression server 116 can include more than one server. The impression server 116 can be coupled to one or more physical storage media and/or one or more cloud storage media, which can be configured to store data for the impression server 116.

The stitching server 104, the secondary content server 114, and the impression server 116 can operate using operating system (OS) software. In some embodiments, the OS software is based on a Linux software kernel and runs specific applications in the stitching server 104, the secondary content server 114, and/or the impression server 116, such as monitoring tasks and providing protocol stacks. The OS software allows resources to be allocated separately for control and data paths. For example, certain packet accelerator cards and packet services cards are dedicated to performing routing or security control functions, while other packet accelerator cards/packet services cards are dedicated to processing network traffic. As network requirements change, hardware resources can be dynamically deployed to meet the requirements in some embodiments.

FIG. 1 shows two embodiments of cloud storage 110 and 112. Cloud storage 110 and/or 112 can store data from physical storage medium 108 with the same restrictions, security measures, authentication measures, policies, and other features associated with the physical storage medium 108. While FIG. 1 shows the cloud storage 112 separate from the communication network 102, cloud storage 112 can also be part of communication network 102 or another communication network. The stitching server 104 can use only cloud storage 110, only cloud storage 112, or both cloud storages 110 and 112. While FIG. 1 shows one cloud storage 110 and one cloud storage 112, more than one cloud storage 110 and/or more than one cloud storage 112 or any suitable combination thereof can be used. In some embodiments, FIG. 1 may not include cloud storage or only one cloud storage.

The communication network 102 can include the Internet, a cellular network, a telephone network, a computer network, a packet switching network, a line switching network, a local area network (LAN), a wide area network (WAN), a global area network, or any number of private networks currently referred to as an Intranet, and/or any other network or combination of networks that can accommodate data communication. Such networks may be implemented with any number of hardware and software components, transmission media and network protocols. While FIG. 1 shows the network 102 as a single network, the network 102 can also include multiple interconnected networks listed above.

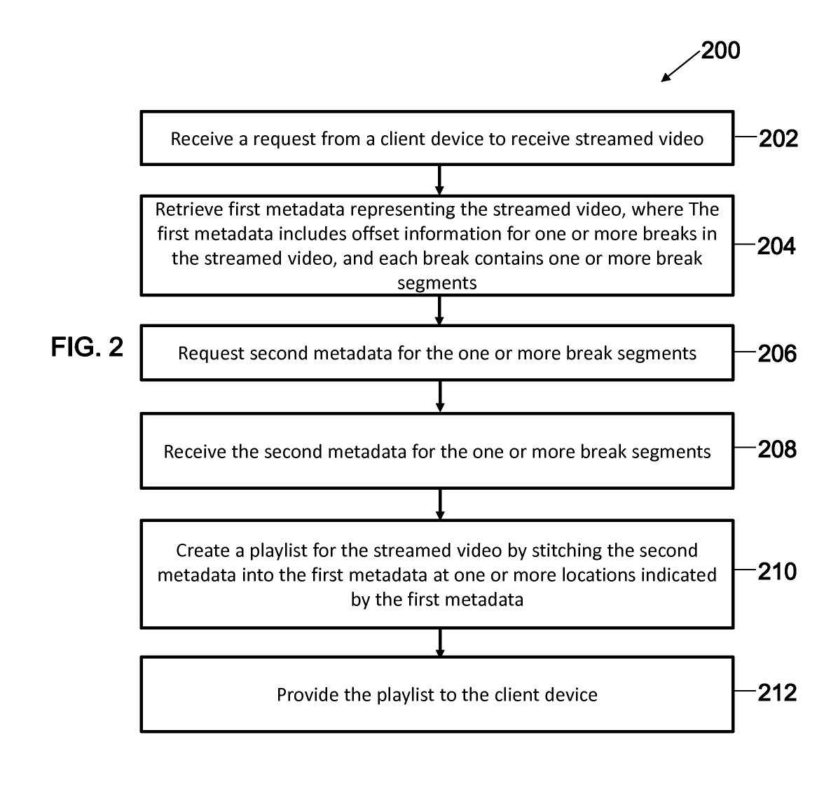

FIG. 2 shows a flow diagram illustrating a computerized process 200 of providing one or more client devices with requested streamed video, according to some embodiments of the disclosed subject matter. The computerized process 200 is illustrated in connection with the networked computing environment 100 shown in FIG. 1. The computerized process 200 can be modified by, for example, having steps rearranged, changed, added, and/or removed.

In step 202, the stitching server 104 receives a request from a client device 106 to receive streamed video. In some embodiments, the request can be sometimes referred to as a client call. In some embodiments, the streamed video can be a full-length episode, multiple episodes, or a subset of an episode. In some embodiments, the request may identify either a unique ID for an episode, which is used when a specific episode ID is known. Alternatively, the request may identify a provider and/or channel name to identify a particular channel, when only the channel that is to be played is known. When a channel is identified, the client device may also optionally include a parameter episode=n to specifies the n^{th} episode in the channel. In some embodiments, the default value for episode is 0. In some embodiments, the request can include a starting offset, which indicates that the client device 106 only requests the portion of the streamed video after the starting offset. The computerized process 200 then proceeds to step 204.

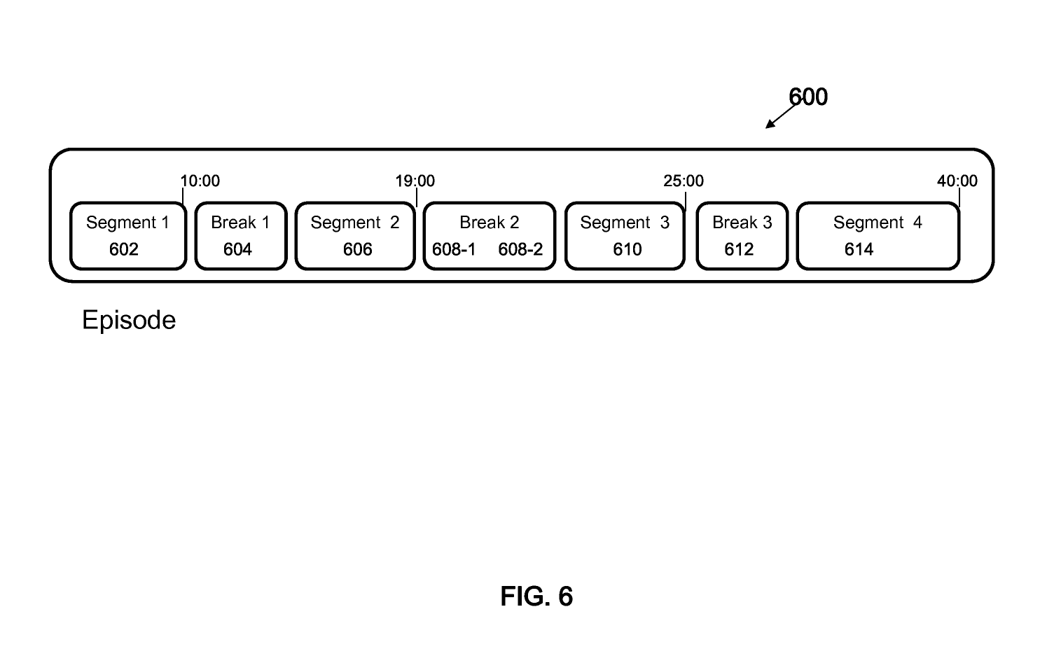

In step 204, the stitching server 104 retrieves first metadata representing the streamed video. The first metadata includes offset information for one or more breaks in the streamed video, and each break contains one or more break segments. FIG. 6 shows a representation of an episode 600 that is requested by the client device 106. In that example, the underlying episode is 40 minutes long and includes offset information for breaks in the episode. For example, FIG. 6 shows Break 1 604 is inserted at 10 minutes from the beginning of the episode, Break 2, which includes two segments 608-1 and 608-2, is inserted at 19 minutes from the beginning of the episode, and Break 3 612 is inserted at 25 minutes from the beginning of the episode. In the example, the episode is composed of four video segments alternating with three breaks, but any combination of segments and breaks are possible, in any order. In addition, the duration of each segment and break can be the same or different. As shown in FIG. 6, the first metadata can be associated with one or more video segments. In some embodiments, the first metadata includes a plurality of links, such that at least one of the plurality of links corresponds to each of the one or more video segments. The computerized process 200 then proceeds to step 206.

In step 206, the stitching server 104 requests, from the secondary content server 114, second metadata for the one or more break segments. Each break segment can be an advertisement segment, a public announcement, and/or other suitable content. A break segment can be referred to as an advertisement break or an ad break when the content of the break segment is an advertisement. The computerized process 200 then proceeds to step 208.

In step 208, the stitching server 104 receives, from the secondary content server 114, the second metadata for the one or more break segments. In some embodiments, the second metadata includes a plurality of second links, such that at least one of the plurality of second links corresponds to each of the one or more break segments. The computerized process 200 then proceeds to step 210.

In step 210, the stitching server 104 creates a playlist for the streamed video by stitching the second metadata into the first metadata at one or more locations indicated by the first metadata. In some embodiments, the playlist is compatible with the HLS protocol. The computerized process 200 then proceeds to step 212.

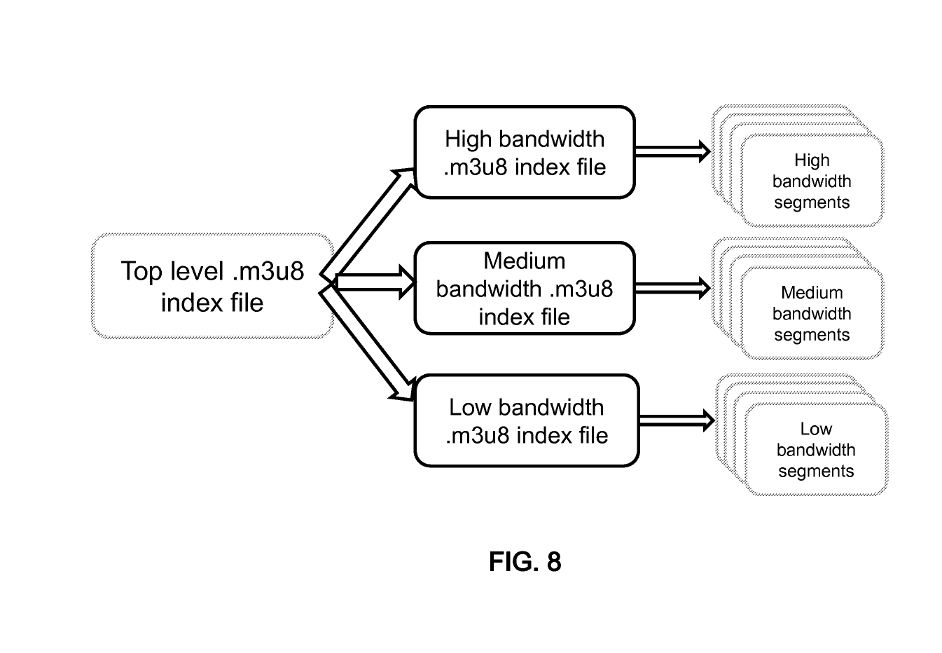

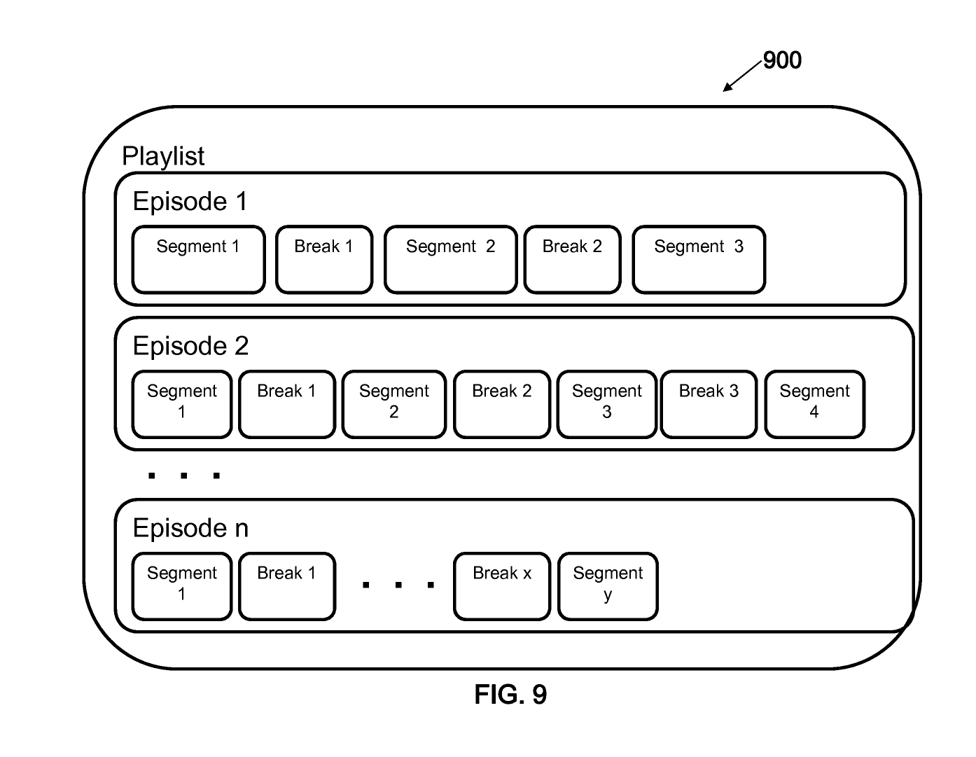

In step 212, the stitching server 104 provides the playlist to the client device 106. In some embodiments, the playlist can include different versions based on the bandwidth of network connection. FIG. 8 shows an exemplary data structure that includes three different playlists based on different bandwidth indices. Although FIG. 8 lists three bandwidth indices (i.e., high bandwidth, medium bandwidth, and low bandwidth), more or less bandwidth indices can be used as well. As a non-limiting example, the high bandwidth, medium bandwidth, and low bandwidth can be 2.5 Mbps, 1.8 Mbps and 1.2 Mbps, respectively. In FIG. 8, each of the three playlists is a stitched stream of one or more episodes comprising segments. In some embodiments, the playlist can also include multiple episodes as requested by the client device. For example, FIG. 9 shows an exemplary playlist that includes three episodes.

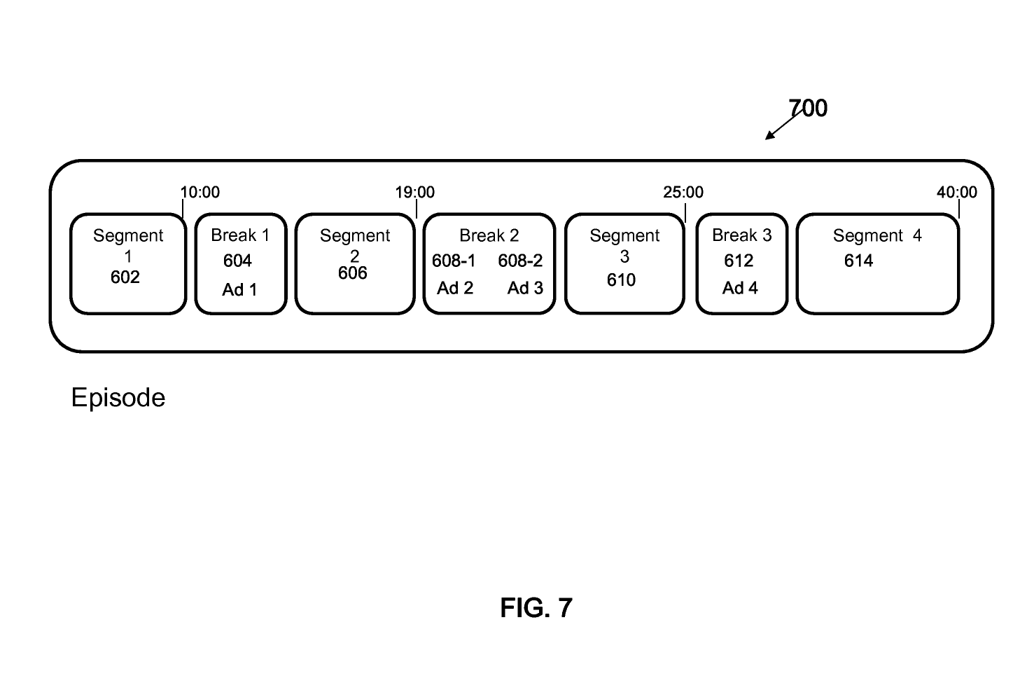

In some embodiments, the client device 106 may request an episode with a starting offset. For example, the client device 106 may request the episode described in FIG. 7 with a starting offset at 19 minutes. In one embodiment, the stitching server 104 could remove the portion of the first metadata that corresponds to content before the starting offset. For example, the stitching server 104 could remove segment 1 602, break 1 604, and segment 2 606 in FIG. 7. In another embodiment, the stitching server 104 could choose not to remove the portion of the second metadata that is associated with the one or more breaks before the starting offset. In that situation, a starting offset can only skip video content but not inserted break content such as one or more advertisements. For example, in that embodiment, the stitching server 104 would remove only segment 1 602 and segment 2 606.

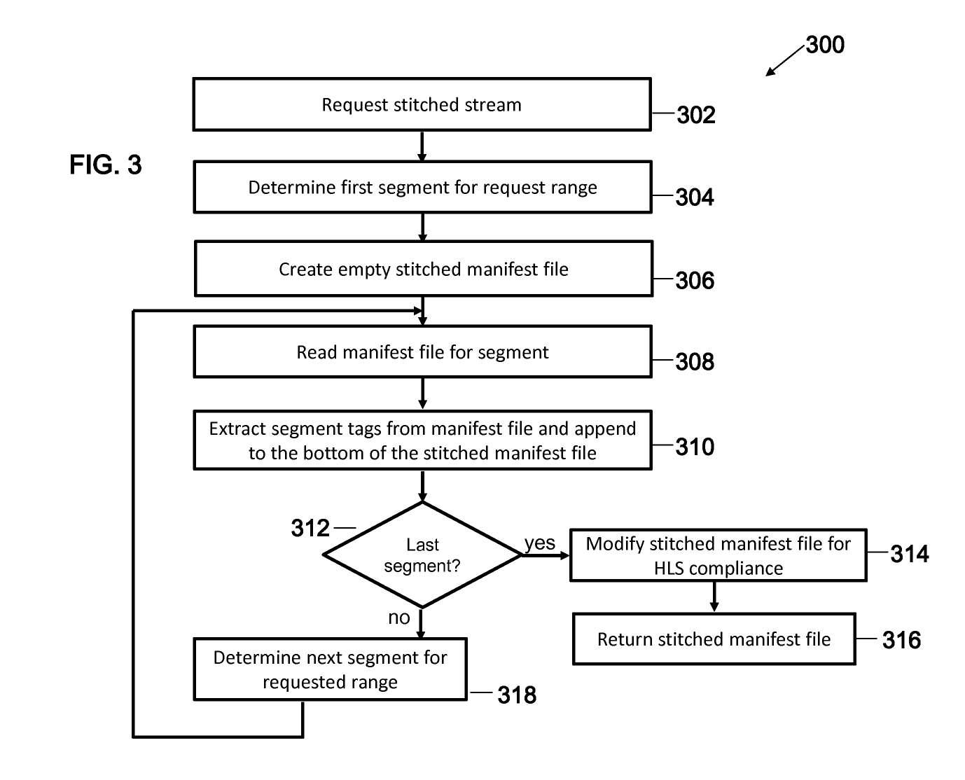

FIG. 3 shows a flow diagram illustrating a computerized process 300 of stitching one or more segments into a playlist, according to some embodiments of the disclosed subject matter. The computerized process 300 is illustrated in connection with the networked computing environment 100 shown in FIG. 1. The computerized process 300 can be modified by, for example, having steps rearranged, changed, added, and/or removed.

In step 302, the client device 106 makes a request to the stitching server 104 for a streamed video. Step 302 is similar to step 202 of the computerized process 200 described in connecting with FIG. 2. The computerized process 300 then proceeds to step 304.

In step 304, the stitching server 104 determines the first segment for the requested streamed video. For example, the client device 106 may request a television episode that is 50 minutes in full-length. Sometimes the requested television episode may be available from a content delivery network, the stitching server 104, or a local cache in multiple shorter segments. As a non-limiting example, there can be ten 5-minute long segments that are corresponding to the requested television episode. The stitching server then identifies the first segment among the ten segments. In some embodiments, the request also includes a starting offset to indicate a range of the streamed video. For example, the request may be for the 50-minute television episode discussed in the earlier example, but only for the last 45 minutes. In this example, the first segment can be the second segment of the original full-length television episode. Furthermore, the segments also include the advertisement, public announcement, and/or other suitable content that are inserted in the one or more segment breaks. The computerized process 300 then proceeds to step 306.

In step 306, the stitching server 104 creates an empty stitched manifest file. The stitched manifest file corresponds to the requested streamed video, such as an episode. The computerized process 300 then proceeds to step 308.

In step 308, the stitching server 104 reads one or more manifest files that correspond to a segment of the requested streamed video. In some embodiments, the manifest file includes one or more links corresponding to the segment that is referred to in this step. In some embodiments, the manifest file is compatible with the HLS adaptive streaming protocol and is in the .m3u8 format with .ts chunks. If the stitched manifest file is empty, then the segment referred to in step 308 is generally the first segment that is determined in step 304. If the first segment has been read by the stitching server 104, then the segment referred to in step 308 is generally the segment that is determined in step 318. The computerized process 300 then proceeds to step 310.

In step 310, the stitching server 104 extracts segment tags from the one or more manifest files that are read in step 308. In some embodiments, a segment tag can be metadata that corresponds to a segment of the requested streamed video, such as, for example, a link to the segment. The stitching server 104 then appends the segment tags to the bottom of the stitched manifest file. The computerized process 300 then proceeds to step 312.

In step 312, the stitching server 104 determines whether or not the last segment of the requested streamed video has been reached. If the last segment has been reached, the computerized process 300 then proceeds to step 314; otherwise the computerized process 300 proceeds to step 318.

In step 318, the stitching server 104 determines the next segment for the requested streamed video. In some embodiments, the next segment can be the next video segment in sequence. In some embodiments, if a segment break is scheduled after the previous segment, then the next segment can be an advertisement, a public announcement, and/or any other suitable content. The computerized process 300 then proceeds to step 308.

In step 314, the stitching server 104 can additionally modify the stitched manifest file to comply with one or more streaming protocols. For example, in some embodiments, the stitching server modifies the stitched manifest file for HLS compliance. The computerized process 300 then proceeds to step 316.

In step 316, the stitching server 104 returns the stitched manifest file to the client device 106. The stitched manifest file is also referred to as a playlist in this invention.

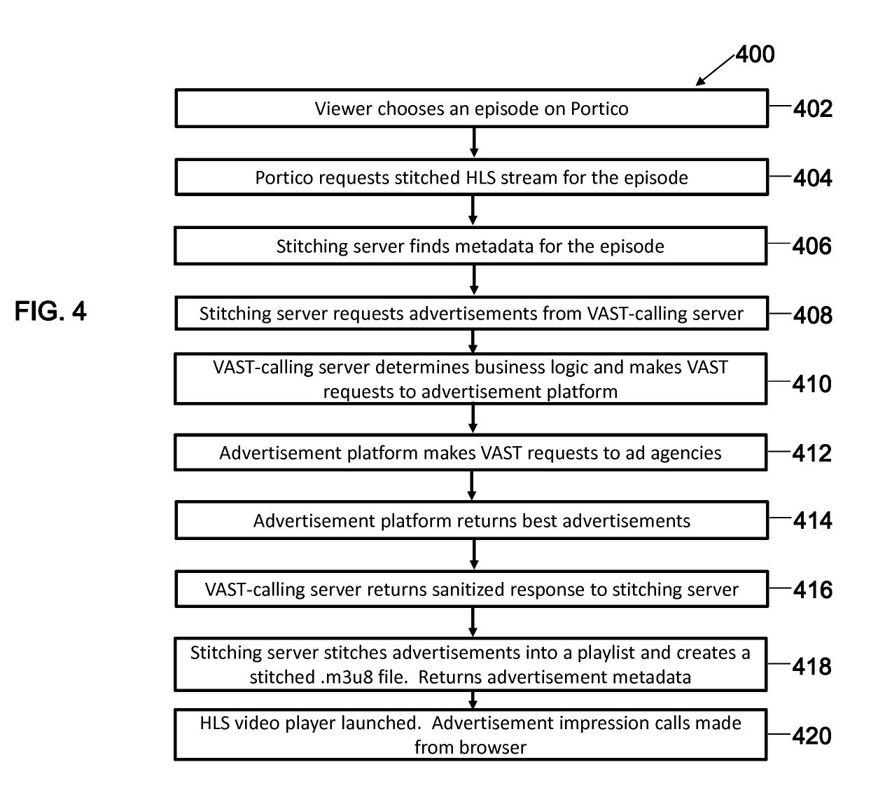

FIG. 4 shows a flow diagram illustrating a computerized process 400 of dynamically inserting advertisements into a stitched playlist, according to some embodiments of the disclosed subject matter. The computerized process 400 can be modified by, for example, having steps rearranged, changed, added, and/or removed. Although the break segments illustrated in the computerized process 400 are one or more advertisements, other suitable content can also be applied. Further, although the computerized process 400 is illustrated in connection with the HLS streaming protocol, other suitable protocols can also be applied to the current invention.

In step 402, the viewer requests an episode from a client device 106. In this particular example, the client device 106 is a Portico media player provided by Net2TV, but any other suitable client devices are also within the spirit of the current invention. The computerized process 400 then proceeds to step 404.

In step 404, the Portico media player requests the stitched HLS stream for the episode. The request is sent to the stitching server 104. The computerized process 400 then proceeds to step 406.

In step 406, the stitching server 104 finds first metadata for the episode. The first metadata includes offset information for one or more breaks in the streamed video, and each break contains one or more break segments. The computerized process 400 then proceeds to step 408.

In step 408, the stitching server 104 requests advertisement and/or advertisement metadata from secondary content server 114. In this example, the secondary content server 114 is compatible with Video Ad Serving Template (“VAST”) and is referred to as a VAST-calling server. The computerized process 400 then proceeds to step 410.

In step 410, the VAST-calling server may optionally execute business rules that specify one or more criteria for an advertisement, and makes a VAST request to an advertisement platform. A non-limiting example of an advertisement platform is LiveRail. The computerized process 400 then proceeds to step 412.

In step 412, the advertisement platform makes VAST requests to one or more advertisement agencies. Non-limiting examples of advertisement agencies include Tremor, YuMe, and Samsung. The computerized process 400 then proceeds to step 414.

In step 414, the advertisement platform returns advertisements found by the one or more advertisement agencies to the VAST-calling server. In some embodiments, the advertisements can be selected, at least partially, based on one or more of the following criteria: whether or not the advertisement is related to the requested episode; the length of the advertisements; and the sponsors of the advertisements. Although FIG. 4 shows steps 410, 412, and 414 as separate steps, in some embodiments, the VAST-calling server and/or the advertisement platform can directly provide advertisements, and steps 410, 412, and 414 can be combined into one or more steps. The computerized process 400 then proceeds to step 416.

In step 416, the VAST-calling server returns an advertisement response to the stitching server. In some embodiments, the advertisement response is metadata representing one or more advertisements found in the previous steps. In some embodiments, the metadata includes one or more links to the one or more advertisements. The computerized process 400 then proceeds to step 418.

In step 418, the stitching server 104 stitches the advertisement segments and the video segments into a playlist. The stitching process is described in detail in connection with FIG. 3. In some embodiments, the stitching server 104 also creates a stitched .m3u8 file to make sure the playlist is compatible with the HLS streaming protocol. FIG. 7 shows a stitched playlist 700, which stitches advertisement metadata into the first metadata depicted in FIG. 6. As a non-limiting example, the stitching server 104 stitches one advertisement (ad 1) at break 1 604, two advertisements (ad 2 and ad3) at break2 608-1 and 608-2, and one advertisement (ad 4) at break 3 612. The stitching server 104 then returns the stitched playlist to the client device 106. In some embodiments, the stitching server 104 also returns advertisement metadata to the client device 106. The computerized process 400 then proceeds to step 420.

In step 420, the client device 106 launches the requested episode based on the playlist. In some embodiments, the client device 106 is a HLS compatible video player, such as the Portico media player. In some embodiments, the advertisement metadata also includes one or more links (the one or more links are also referred to as advertisement impressions) that can be used by the client device 106 to notify an advertisement server, such as the secondary content server 114 or the impression server 116, each time an advertisement is played, in whole or in part, by the client device 106.

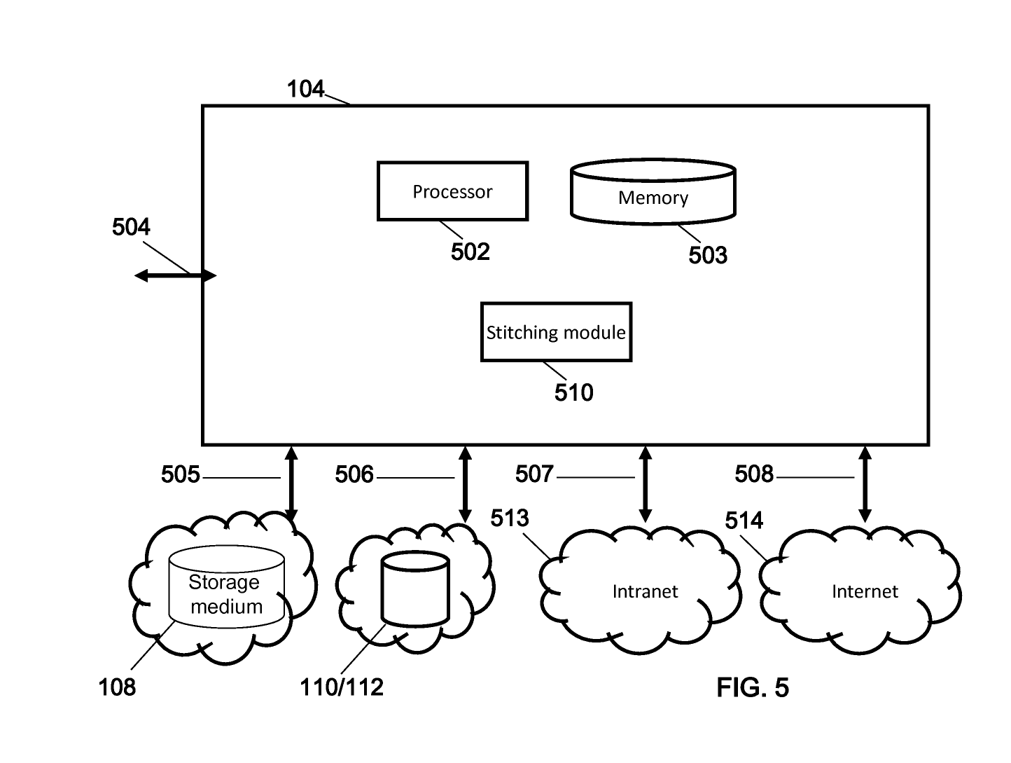

FIG. 5 is a block diagram of an exemplary stitching server 104 in accordance with some embodiments. The stitching server 104 includes a processor 502, a memory 503, and interfaces 504-508. The stitching server 104 can communicate with other servers (not shown) via the interface 504; the server 104 can communicate with the local network storage 108 via the interface 505; the server 104 can communicate with the remote network storage 110 via the interface 506; the server 104 can communicate with the Intranet 513 via the interface 507; and the server 104 can communicate with the Internet 514 via the interface 508. The interfaces 504-508 are shown as separate interfaces but may be the same physical interface. The stitching server 104 may include additional modules, fewer modules, or any other suitable combination of modules that perform any suitable operation or combination of operations. For example, the stitching server 104 may include more than one processor 502.

The interfaces 504-508 provide an input and/or output mechanism for communication. In some cases, the interfaces 504-508 can be used to communicate within the computing system. For example, the processor 502 can use one of the interfaces 504-508 to communicate with memory 503. In other cases, the interface 504-508 can be used to communicate over a network. The interfaces 504-508 enable communication with other computing systems, such as the stitching server 104, the secondary content server 114, and/or the impression server 116, as well as other network nodes in the communication network 102. The interfaces 504-508 can be implemented in hardware to send and receive signals in a variety of mediums, such as optical, copper, and wireless, and in a number of different protocols, some of which may be non-transient.

In some embodiments, the processor 502 can include one or more cores and can accommodate one or more threads to run various programs, applications, and modules, including the stitching module 510.

The stitching module 510 can be configured to cause one or more processors to receive a request from a client device to receive streamed video. The stitching module 510 can be configured to cause one or more processors to retrieve first metadata representing the streamed video, wherein the first metadata includes offset information for one or more breaks in the streamed video, wherein each break contains one or more break segments. The stitching module 510 can be configured to cause one or more processors to request, from a first server, second metadata for the one or more break segments. The stitching module 510 can be configured to cause one or more processors to receive, from the first server, the second metadata for the one or more break segments. The stitching module 510 can be configured to cause one or more processors to create a playlist for the streamed video by stitching the second metadata into the first metadata at one or more locations indicated by the first metadata. The stitching module 510 can be configured to cause one or more processors to provide the playlist to the client device.

In some embodiments, the stitching module 510 can also be configured to cause one or more processors to receive a request for a stitched playlist or a range of a stitched playlist, where a playlist is a collection of episodes such as described in FIG. 9.

In some embodiments, the module 510 can be implemented in software stored in the memory 503. The memory 503 can be a non-transitory computer readable medium, flash memory, a magnetic disk drive, an optical drive, a programmable read-only memory (PROM), a read-only memory (ROM), or any other memory or combination of memories. The software can run on a processor 502 capable of executing computer instructions or computer code. The processor 502 might also be implemented in hardware using an application specific integrated circuit (ASIC), programmable logic array (PLA), field programmable gate array (FPGA), or any other integrated circuit. The processor also communicates with the memory and interfaces to communicate with other devices. The processor can be any applicable processor such as a system-on-a-chip that combines a CPU, an application processor, and flash memory.

The following sections describe how the stitching process is implemented by programming codes in some embodiments. Specifically, the programming codes are described in connection with Net2TV platform and are compatible with HLS protocol. However, the current invention can also be implemented by any other suitable streaming protocols and on any other suitable platforms. Further, Appendix A shows an exemplary file for a stitched episode, and Appendix B shows an application program interface (API) of a stitching server. Both Appendix A and Appendix B are incorporated herein in their entireties.

### Episode Stitching—Standard HLS Streams

In the Net2TV system, the top level file is named playlist.m3u8 in one embodiment and is reached by its full pathname. For example,
http://video.net2.tv/PORTICO/NEWS/APNews/April_{—}7-11_{—}2014/April_{—}7_{—}2014/APN_{—}20140407_AM_A/playlist.m3u8
#EXTM3U
#EXT-X-STREAM-INF:PROGRAM-ID=1,BANDWIDTH=2500000
hls_APN_{—}20140407_AM_A_{—}2500.m3u8
#EXT-X-STREAM-INF:PROGRAM-ID=1,BANDWIDTH=1800000
hls_APN_{—}20140407_AM_A_{—}1800.m3u8
#EXT-X-STREAM-INF:PROGRAM-ID=1,BANDWIDTH=1200000
hls_APN_{—}20140407_AM_A_{—}1200.m3u8

In one embodiment, advertisements are selected dynamically by a server-side VAST-calling system for each defined break, which can also be referred to as an Ad Break. The results from the VAST server contain similar uniform resource locators (URLs) to top-level manifest files. For example,
http://video.net2.tv/linearCreatives/533e907e96dc421412000537/ysijfubF_{—}1600K_{—}1280x720/playlist.m3u8
#EXTM3U
#EXT-X-STREAM-INF:PROGRAM-ID=1,BANDWIDTH=2500000
hls_ysiffubF_{—}1600K_{—}1280x720_{—}2500.m3u8
#EXT-X-STREAM-INF:PROGRAM-ID=1,BANDWIDTH=1800000
hls_ysiffubF_{—}1600K_{—}1280x720_{—}1800.m3u8
#EXT-X-STREAM-INF:PROGRAM-ID=1,BANDWIDTH=1200000
hls_ysiffubF_{—}1600K_{—}1280x720_{—}1200.m3u8

In one embodiment, instead of making requests to the content delivery network for each .m3u8 file, and playing each of the segments in the episode individually (as in the prior art approach), a HLS compliant HLS player can request a single stitched HLS stream from Net2TV's playlist stitching server. The Net2TV playlist stitcher then determines the set of required manifest files and either requests the manifest files from the content delivery network, or retrieves the manifest files from a local cache. After obtaining the manifest files, the stitcher then repackages the response before sending the response back to the client device.

### Client Process

For the client device to play a single, stitched episode, the client makes a call to the playlist stitching server. In one embodiment, the client call may identify a unique ID for an episode, which is used when a specific episode id is known. Alternatively, the client call may identify a provider and channelName to identify a particular channel, when only the channel that is to be played is known. When a channel is identified, the client device may also optionally include a parameter episode=n to specifies the n^{th} episode in the channel. The default value for episode is 0.

In one embodiment, the response to either call is a .JSON object (MIME application/json) that points to a stitched top-level .m3u8 file, information about each stitched advertisement, and other relevant information.

In a preferred embodiment, the structure for the returned .JSON object is shown below:

episode:
{

episodeID : <episodeid>,
duration : <episode duration, excluding adbreak durations>
hls : http://playlist.portico.net2.tv/stitched/:stitchedid.m3u8,
segmentSize: 5
startingOffset: 5,
adbreaks : [ Array of adbreaks ],
thumbnails : { thumbnail information },

}

In the example object shown above, episode.hls is the URL for the top-level .m3u8 manifest file for the stitched stream. The episode.segmentSize indicates the size (in seconds) of each .ts chunk in the HLS stream. The episode.startingOffset indicates (in seconds) the starting time for the start of the HLS stream. In this example, the HLS stream starts with a timestamp of 5 seconds.

In prior art systems, the client would know when to trigger an ad-viewing event, because it would know when it was playing each advertisement. However, once the advertisements are stitched into the media content to create one stream, the client is unable to distinguish between advertisement content and episode content. In order for the client application to know when to trigger an event to indicate the playing of an advertisement, it must obtain additional information from the server. In some embodiments, this information is provided by the server in the form of an adbreaks array, which informs the client of the time offset for each event, for each advertisement, in each adbreak, and the appropriate URL to call for each such event.

In one embodiment, each entry in the episode.adbreaks array contains the following data:

adbreaks:
{

offset : <seconds from start of episode>,
ads : [ Array of ads ]

}
Each adbreak can have one or more advertisements, presented in the
adbreak.ads
array:
ads:
{

duration : <advertisement duration in seconds>,
events : [ Array of ad events ]

}

In one embodiment, the ads.events object is the same as the events returned by the VAST-calling server—it lists the standard set of advertisement impressions with a list of tracking URLs for each impression. For example,

events:
{ impression:

{ type: ‘impression’,

urls: [ http://url.1, http://url.2] },

start:

{ type: ‘start’,

urls: [ http://url.3 ] },

creativeView: { type: ‘creativeView’, urls: [ ] },
firstQuartile:

{ type: ‘firstQuartile’,

urls: [http://url.4] },

midpoint:

{ type: ‘midpoint’,

urls: [http://url.5] },

thirdQuartile:

{ type: ‘thirdQuartile’,

urls: [http://url.6] },

complete:

{ type: ‘complete’,

urls: [http://url.7] } }

In one embodiment, the episode.adbreaks array contains all the information needed by the client application running on the client device to fire event triggers when advertisements are played. The client application is responsible for calling the event URLs at the right offset in the stream.

In one embodiment, the episode's duration is the sum of the durations of the video segments in the episode, excluding the advertisement time. The offset values in the adbreaks array is the starting offset of the adbreak in the episode. When it comes to calculating stream offset and playhead position, the adbreak duration is effectively zero. The advertisement duration is included in this data so the client can calculate the playhead's position within the advertisement so as to ensure that it fires an “event URL” at the correct time. In one embodiment, the event URL is a simple HTTP GET request that is sent to the logging servers for the advertiser that provided the advertisement. When an advertiser receives the HTTP GET request, it knows that a video has been started. Each advertisement can be associated with one or more events, to indicate such things as when the player has played the first quartile of the advertisement, when the player has played half the advertisement, when the player has played three quarters of the advertisement, and when the player has played the complete advert. Standards defining when event URLs can be triggered based on advertisement viewing are promulgated by the Interactive Advertising Bureau, and include such documents as the “Digital Video Ad Impression Measurement Guidelines” (Formerly titled “Broadband Video Commercial Measurement Guidelines”), updated December 2009, and the “Interactive Audience Measurement and Advertising Campaign Reporting and Audit Guidelines, Global Version,” Version 6.0b, September 2004, which are incorporated herein by reference.

### Episode Stitcher Query Parameters

In one embodiment, the stitching server takes the following optional query parameters, which must be used at the correct situation:
seekFrom=<offset>
seekTo=<offset>
   Together, these parameters are used after seeking in the stream.

In one embodiment, for the /episode/stitched/:provider/:channelName.json URL, following parameters can be used:
episode=<episode number>
   This parameter specifies which episode number in the channel to stitch. The first episode number is 0. If the <episode number> is greater than the number of episodes in the channel, then the channel numbers wrap (modulo number of channels in the episode).
clientVersion=<version>
   This parameter should be passed when the client's firmware version is known.

In some embodiments, the stitching server can additionally or alternatively take the following query parameters:
clientID=<client ID>
   This parameter passes the client device's unique ID with the request.
   Playing from the Beginning

In one embodiment, if the viewer chooses to play an episode from the start, the client device makes a simple request to the stitching server URL. For example, for episode id 5335a9b284a74500000429fb, the request to the stitching server URL can be: http://playlist.portico.net2.tv/episode/stitched/5335a9b284a74500000429fb.json?clientID=Roku-3100X_{—}13C25M003577-BF8B&clientVersion=1.5. This returns the data for the stitched stream, advertisement breaks and/or other suitable content as described in this invention.

### Resume Playback

In one embodiment, if the viewer chooses to resume playback of an episode (/episode/stitched/:episodid.json), the client device makes the same request to the stitching server URL. The client is then responsible for setting the starting offset when playback is started.

In one embodiment, if the viewer chooses to resume playback of a channel (/episode/stitched/:provider/:channeljson) the client device can append ?resume=true to the URL. The server will look up the last known playhead position for the named client for the given channel. The last known position will be returned in the .json response as

{

...
playheadPosition
{

episodeNumber: n
startingOffset: m <seconds from start of episode>

}

}

Note that passing ?resume=true will override the ?episode=n parameter if set.

### Resume After Seeking

In one embodiment, to resume playback after seeking, the client device needs to make a request for a new stitched stream. This is because the logic for deciding how to present advertisements that may have been sought in the past resides with the server. For example, if the viewer was watching at offset 310 and then sought to offset 715: http://playlist.portico.net2.tv/episode/stitched/5335a9b284a74500000429fb.json?clientID=Roku-3100X_{—}13_C25M003577-BF8B&clientVersion=1.5&seekFrom=310&seekTo=715, the playlist stitcher will then see that an Ad Break has been skipped, and will return a new stitched HLS stream that starts with an advert.

In one embodiment, depending on the client device, this new stitched stream may or may not be shortened to just the manifest information for the new position through to the end.

### End of Stream

In one embodiment, the HLS streams are terminated at the end of the episode with the HLS segment EXT-X-ENDLIST.

### Stream Discontinuity

In one embodiment, the stitched stream makes use of the #EXT-X-DISCONTINUITY HLS tag. This tag can be inserted in the stream between video segments and advertisement segments to indicate to the HLS player that there's a new video with discontinuous timestamps. The device's HLS player must support #EXT-X-DISCONTINUITY tag, otherwise playback may be corrupted at the video segment boundaries.

### Episode Playback HUD

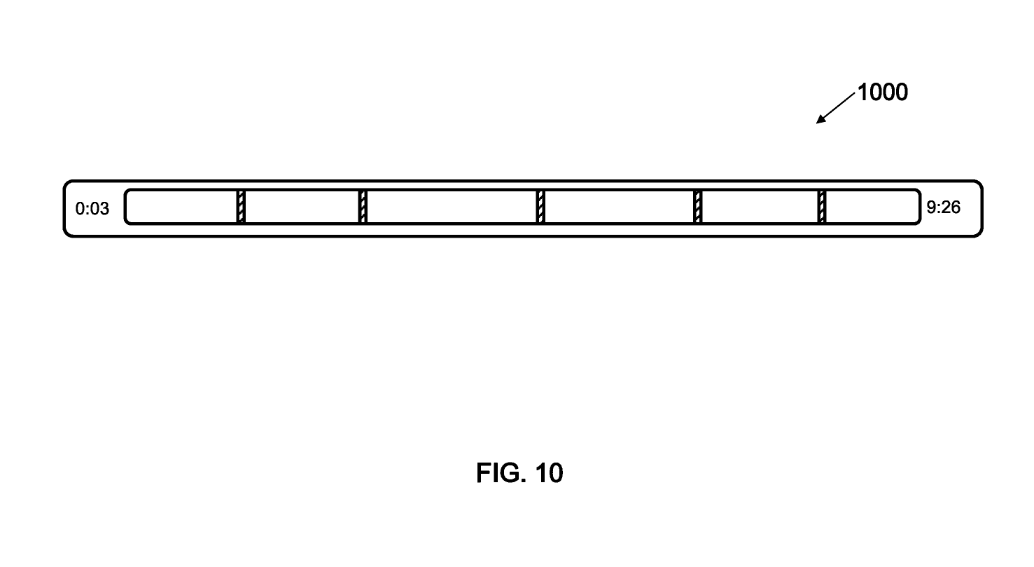

Using the episode/stitched information, the video player can display the position of ad breaks in a playbar. For example, FIG. 10 shows an exemplary playbar 1000, according to some embodiments of the disclosed subject matter. In FIG. 10, each vertical bar represents an ad break. The duration of each ad breaks can be different or the same, and the distance between any two adjacent ad breaks can be different or the same.

### Playlist Stitching—1.0 Compatibility

The stitching server will continue to support the old 1.0-style API for compatibility with existing Philips television firmware. This API works in conjunction with Net2TV's proprietary HLS stitcher that works by presenting a range of HLS manifest information.

The URL is as follows:
http://playlist.portico.net2.tv/playlist/m3u8/<playlistid>/<name>.m3u8 with the following query parameters:
start=<starting offset>
end=<ending offset>
clientID=<client ID>
clientVersion=<client version>
seekFrom=<offset seeking from>
terminate=<terminate the stream>
   playlistid is the unique ID of a Playlist, which in turn contains all the episodes for a particular channel. This API knows how to stitch continuous episodes together as well as stitch together continuous videos within the episode. For this reason, this mode is also known as “playlist mode”.

An exemplary usage would be:
http://playlist.portico.net2.tv/playlist/m3u8/<id>/content.m3u8?start=0&end=300
   After 300 seconds, the client would make the next request:
http://playlist.portico.net2.tv/playlist/m3u8/<id>/content.m3u8?start=300&end=600

If the viewer chooses to resume an episode instead of playing from the beginning, for example, resume from offset 125, then the request can be:
http://playlist.portico.net2.tv/playlist/m3u8/<id>/content.m3u8?start=125&end=425

In this way, the playlist stitching server can stitch segments and advertisements together for a single playlist across multiple episodes, without having to generate a long single .m3u8 file for the entire playlist.

Although the disclosed subject matter has been described and illustrated in the foregoing exemplary embodiments, it is understood that the present disclosure has been made only by way of example, and that numerous changes in the details of implementation may be made without departing from the spirit and scope, which is limited only by the claims which follow.

A “server,” “client,” “agent,” “module,” “interface,” and “host” is not software per se and includes at least some tangible, non-transitory hardware that is configured to execute computer readable instructions. In addition, the phrase “based on” does not imply exclusiveness—for example, if X is based on A, X can also be based on B, C, and/or D.

1. A computerized method, comprising:
receiving, by a first server, a request from a client device to receive streamed video;
retrieving, by the first server, first metadata representing the streamed video, wherein the first metadata includes offset information for one or more breaks in the streamed video, wherein each break contains one or more break segments;
requesting, by the first server from a second server, second metadata for the one or more break segments;
receiving, by the first server from the second server, the second metadata for the one or more break segments;
creating, by the first server, a playlist for the streamed video by stitching the second metadata into the first metadata at one or more locations indicated by the first metadata; and
providing, by the first server, the playlist to the client device.

2. The method of claim 1, wherein the playlist is compatible with the Hypertext Transfer Protocol (HTTP) Live Streaming protocol.

3. The method of claim 1, wherein the first metadata is associated with one or more video segments.

4. The method of claim 3, wherein the first metadata includes a plurality of first links, such that at least one of the plurality of first links corresponds to each of the one or more video segments.

5. The method of claim 1, wherein the second metadata includes a plurality of second links, such that at least one of the plurality of second links corresponds to each of the one or more break segments.

6. The method of claim 5, wherein the at least one of the plurality of second links can be used by the client device to notify a third server each time the corresponding one or more break segments are played, in whole or in part, by the client device.

7. The method of claim 1, further comprising:
receiving, by the first server, a starting offset associated with the request; and
removing, by the first server, a portion of the first metadata from the playlist, wherein the portion of the first metadata corresponds to content before the starting offset.

8. The method of claim 7, further comprising removing, by the first server, a portion of the second metadata from the playlist, wherein the portion of the second metadata is associated with the one or more breaks before the starting offset.

9. An apparatus, comprising:
one or more processors;
a memory storing a program that, when executed, causes the one or more processors to:
receive a request from a client device to receive streamed video;
retrieve first metadata representing the streamed video, wherein the first metadata includes offset information for one or more breaks in the streamed video, wherein each break contains one or more break segments;
request, from a first server, second metadata for the one or more break segments;
receive, from the first server, the second metadata for the one or more break segments;
create a playlist for the streamed video by stitching the second metadata into the first metadata at one or more locations indicated by the first metadata; and
provide the playlist to the client device.

10. The apparatus of claim 9, wherein the playlist is compatible with the Hypertext Transfer Protocol (HTTP) Live Streaming protocol.

11. The apparatus of claim 9, wherein the first metadata is associated with one or more video segments.

12. The apparatus of claim 11, wherein the first metadata includes a plurality of first links, such that at least one of the plurality of first links corresponds to each of the one or more video segments.

13. The apparatus of claim 9, wherein the second metadata includes a plurality of second links, such that at least one of the plurality of second links corresponds to each of the one or more break segments.

14. The apparatus of claim 13, wherein the at least one of the plurality of second links can be used by the client device to notify a second server each time the corresponding one or more break segments are played, in whole or in part, by the client device.

15. The apparatus of claim 9, wherein the program, when executed, further causes the one or more processors to:
receive a starting offset associated with the request; and
remove a portion of the first metadata from the playlist, wherein the portion of the first metadata corresponds to content before the starting offset.

16. The apparatus of claim 15, wherein the program, when executed, further causes the one or more processors to remove a portion of the second metadata from the playlist, wherein the portion of the second metadata is associated with the one or more breaks before the starting offset.

17. A non-transitory computer readable medium comprising executable instructions operable to cause an apparatus to:
receive a request from a client device to receive streamed video;
retrieve first metadata representing the streamed video, wherein the first metadata includes offset information for one or more breaks in the streamed video, wherein each break contains one or more break segments;
request, from a first server, second metadata for the one or more break segments;
receive, from the first server, the second metadata for the one or more break segments;
create a playlist for the streamed video by stitching the second metadata into the first metadata at one or more locations indicated by the first metadata; and
provide the playlist to the client device.

18. The non-transitory computer readable medium of claim 17, wherein the playlist is compatible with the Hypertext Transfer Protocol (HTTP) Live Streaming protocol.

19. The non-transitory computer readable medium of claim 17, wherein the first metadata is associated with one or more video segments.

20. The non-transitory computer readable medium of claim 19, wherein the first metadata includes a plurality of first links, such that at least one of the plurality of first links corresponds to each of the one or more video segments.

21. The non-transitory computer readable medium of claim 17, wherein the second metadata includes a plurality of second links, such that at least one of the plurality of second links corresponds to each of the one or more break segments.

22. The non-transitory computer readable medium of claim 21, wherein the at least one of the plurality of second links can be used by the client device to notify a second server each time the corresponding one or more break segments are played, in whole or in part, by the client device.

23. The non-transitory computer readable medium of claim 17, wherein the executable instructions are further operable to cause the apparatus to:
receive a starting offset associated with the request; and
remove a portion of the first metadata from the playlist, wherein the portion of the first metadata corresponds to content before the starting offset.

24. The non-transitory computer readable medium of claim 23, wherein the executable instructions are further operable to cause the apparatus to cause the processor to remove a portion of the second metadata from the playlist, wherein the portion of the second metadata is associated with the one or more breaks before the starting offset.
